(19) United States
(12) Patent Application Publication
(10) Pub. No.: US 2026/0098312 A1
(43) Pub. Date: Apr. 9, 2026

(54) GRAFTED POLYMER OF MONO-UNSATURATED POLYCARBOXYLIC ACID AS DYEING AUXILIARY OR AS RE-TANNING AGENT FOR LEATHER

(71) Applicant: Stahl International B.V., Waalwijk (NL)

(72) Inventors: Roberta GAMARINO, Casale Monferrato (IT); Debora CICOLIN, Cesate (IT); Mattia NAZZARO, Milano (IT); Debora SPENGLER, Filderstadt (DE); Cristina BALLESTER SOLANO, Sant Feliu de Llobregat (ES)

(21) Appl. No.: 19/110,665

(22) PCT Filed: Sep. 20, 2023
(86) PCT No.: PCT/NL2023/050487

§ 371 Date: Mar. 11, 2025

(30) Foreign Application Priority Data
Sep. 20, 2022 (NL) 2033083

(51) Int. Cl. C14C 3/22; C08F 222/02; C08F 251/02

(52) U.S. Cl. CPC C14C 3/22; C08F 222/02; C08F 251/02

(57) ABSTRACT

The present invention relates to a novel graft polymer obtainable by polymerizing one or more mono-unsaturated polycarboxylic acids in the presence of naturally occurring polyols or naturally occurring polymers, which can be used as dyeing auxiliary or re-tanning agent for leather, hides and/or pelts providing good dye intensity, dye levelness, tightness, heat resistance and good lightfastness according to ISO105-B02 and/or to ISO105-B06 and a favourable BOB₅/COD ratio.

The present invention relates to a novel composition that can be used as dyeing auxiliary for leather (the term “leather” encompassing fur skins, hides or pelts) or as a re-tanning agent for leather. In particular the present invention relates to specific graft polymers, a process for their preparation and their application.

Leather is a durable, flexible material created via the tanning of animal rawhide and skin. The leather manufacturing process is divided into three fundamental sub-processes: preparatory stages, tanning and crusting.

The present invention relates to the sub-process of crusting, especially the colouring part and re-tanning part thereof.

In the preparatory stages, hide or skin is prepared for tanning. After trimming, animal skin is soaked to remove salts and other solids, while restoring moisture when the skin was first dried. Then, the flesh side of the wet skin is scraped to remove any remaining traces of flesh or fat, and the skin is optionally dehaired. After an optional bating and pickling step, the skins are subjected to tanning. Other potential steps that may be part of the preparatory stages include preservation, liming, splitting, reliming, deliming, degreasing, frizzing, bleaching and depickling.

Tanning is the process of preserving the skins by converting the protein, and especially the collagen, of the raw hide or skin into a stable material that does not putrefy and provides tanned leathers with satisfactory properties, such as high shrinkage temperatures Ts, suppleness and suitability for subsequent processing such as neutralization, re-tanning, fatliquoring, dyeing, finishing.

Tanning is carried out by using either vegetable chemicals, using tannin and other ingredients derived from vegetable matter such as the bark of certain trees, by the use of chromium salts (giving so-called wet-blue leather), by the use of aldehydes (resulting in wet-white leather), by the use of organic reactive tanning agent (resulting in wet-white leather), by use of synthetic tannins (syntans), or other conventional techniques. The product prepared in this sub-process is called “tanned leather”.

As said, the present invention focuses on the sub-process of crusting, and especially on the colouring and re-tanning part thereof. Crusting is the process wherein the tanned hide or skin is thinned, re-tanned, and lubricated, and often a colouring operation is included in the crusting sub-process. Any chemicals used or added during crusting must be fixated in place. The crusting process ends with drying and softening operations. This description of the crusting process is not complete; crusting may also include wetting back, sammying, splitting, shaving, rechroming, neutralization, filling, stuffing, stripping, whitening, fixating, setting, conditioning, milling, staking and buffing.

The chemical aspects of the crusting process at least encompass re-tanning (optionally following neutralization, especially after chrome-tanning) and fatliquoring. Usually in the preparation of leather from tanned hides, the re-tanning and fatliquoring is done in separate steps.

The initial colour of a leather is dependent on the tanning agents used. Tannins of plants give the leather a brownish tone, whereas fat and oil tanning makes leather yellowish, while tanning with alum and synthetic tanning agents give the leather a whitish tone and chrome tanning makes it bluish-greyish. These are often not the colours desired by customers and hence the tanned leather needs to undergo a colouring step. In the colouring of leather, two main colouring methods are distinguished. The first process involves dyeing the leather with dyes and the second one involves pigmentation of the surface with binder-based colours. The present invention concerns the dyeing of leather.

Most leather is first dyed through completely. This is usually done with liquid dye like ink that is also used for colouring of textiles. Dyes dissolve and can thus penetrate everywhere. Pigments are solid particles that remain on the outside of the fibres and hence a through colouring cannot be obtained by using pigments. For this purpose, the leather is immersed in a dye bath in rotating barrels. The dye has to be fixed and excess colour has to be rinsed out to prevent dye transfer from leather. There are leathers that are not further coated and then the dyeing is the only colouring that is applied onto the leather, such as aniline leather, nubuck and suede. Other leathers can be further coated with finish layers that may contain dyes and pigments, but nevertheless these leathers are usually dyed through anyway, so that leathers with mechanical damages to the finish still have a similar colour tone in the area of the damage.

Dyeing of leather is an intricate process. Leather dyes refer to dyes with an affinity to leather and for leather colouring. Leather is dyed mainly by means of selected acids, substantive or metal-complex dyes and, to a minor extent, basic dyes. Further, in some cases, superficial dyeing or surface colouring is required whereas in the case of shoe leather and garment leather, certain degree of penetration is desired which will resist or minimize further buffing or scuffing of the leather surface.

Based on solvent types, dyes can be divided into two categories: non-water-soluble dyes and water-soluble dyes. Non-water-soluble dyes comprise: sulphur dyes soluble in aqueous solution of sulphide; fat-soluble oil-soluble dyes and alcohol-soluble dyes. Water-soluble dyes include: anionic acid dyes; direct dyes; special dyes for leather; amphoteric metal complex dyes; triphenylmethane dyes of sulphite and cationic alkaline dyes.

There are three techniques to dye leather: dip dyeing, sponging or brush dyeing and spray dyeing.

Dip dyeing is one of the most common leather dyeing techniques used in tanneries. The hides are introduced into a drum and soaked in a considerable quantity of water containing the leather dye. Generally, to increase the penetration of the dyes inside the leather fibres the temperature is raised to 50-60° C., and the rotary movement of the drum further favours the penetration of the leather dyes.

Sponging is used in tanneries when it is necessary to colour delicate leathers, for example for the production of glove articles, where the prerogative is to maintain the original softness of the leather that could be altered by the strong mechanical action of the drum or to colour high quality leather articles, for example shoes, garment or upholstery articles. This artisanal leather colouring technique is still used today in some tanneries, but only for the production of very fine leathers, as the cost of labour for colouring is high.

Spraying is used in tanneries as a valid alternative to drum and is generally carried out using a special machine, consisting of a carousel rotary machine with spray guns that rotate and spray leather dye simultaneously on the leather. The spraying technique has considerably shortened the industrial production times as it is a very rapid process and requires a minimum employment of labour. Often it is used to modify the colour of the leather already dyed in drum.

Dyeing auxiliary agents are needed in the dyeing process to achieve a uniform dyeing and through-dyeing of the leather, which is done by improving the penetration of the dyeing agents through and into the leather. However, the dyeing auxiliary agent should not influence colour depth, meaning the intensity of colour, at the surface of the leather.

Primary tanning is not always sufficient to obtain the desired characteristics specified by the customer. The “tanned leather” obtained from the tanning process as described hereinbefore is therefore re-tanned. The tannins used for this process are different from those used in the primary tanning stage. This process is called combination tanning. Re-tanning affects the feel of the leather, the dyeability, fullness of the leather, the fineness of the grain and the stability of grain and other factors such as light fastness, to suit characteristics required for the end product—whether for automotive or aviation seating, footwear, garments or bags and leather goods. Re-tanning includes dyeing to give colour and fatliquoring to add softness, fullness and touch. Once re-tannage is complete, the leather is known as “crust”.

Vegetable tanning agents were the first tanning agents. They are now only used in the re-tanning, because of the nowadays wide acceptance of chromium sulphate or glutaraldehyde as tanning agents. Common vegetable tanning agents are Mimosa, obtained from the bark of the Mimosa tree, and Tara, obtained from the fruits of the Tara tree. They can impose softness and limited filling of the collagen structures to leathers (Hans Herfeld, “Library of Leather; Volume 3: Tanning Agents, Tanning and Re-tanning”, Frankfurt 1985, page 44). Usually, vegetable tanning agents lack fastness properties, such as resistance to light or resistance to heat induced ageing and therefore vegetable tanning agents are not much used anymore in re-tanning.

The term syntan refers to the range of synthetic tanning agents. The first syntans were made by condensation of phenol sulfonic acid and formaldehyde (E. Stiasny, 1911, Austrian Patent Nr. 58405). These syntans could be applied as tanning agents replacing some or even all vegetable tannins after further development of their chemistry. U.S. Pat. No. 1,841,840 describes the incorporation of urea into the polycondensation of phenol sulfonic acid and formaldehyde, whereby such a further development was achieved, enabling to obtain leathers with increased technical requirements such as fastness properties concerning light or heat induced ageing.

Because of the wide acceptance of chromium sulphate or glutaraldehyde as tanning agents, syntans are now mainly used in the re-tanning process, where they help to structure and fill the crosslinked collagen fibres. Unfortunately, syntans contain a residual amount of free formaldehyde, which means that they should be handled and used with care due to safety reasons.

In many applications syntans and vegetable tannins are applied together, since the performance of vegetable tannins alone is considered insufficient. The syntans generally have higher fastness properties and have to provide dispersing properties in order to support the even distribution of vegetable tannins and other leather chemicals as fillers, dyes, and fat liquors (F. W. Guthke et al., DE 1142173, 1959).

Polyacrylics are an alternative family of re-tanning agents, which have as advantage over syntans that polyacrylics do not have residual amounts of phenol or formaldehyde in them. Such resin types of re-tanning agents are already known for a long time, as exemplified by EP0016420B2 from 1982, but they are still of interest, as exemplified by a publication from 2020: “Novel approaches in the use of polyacrylate ester-based polycarboxylates (PCEs) as leather re-tanning agents” in Mater. Adv., 2020, 1, 3378-3386. However, such polyacrylics have as disadvantage that they are made from fossil based materials, thus not renewable, and furthermore their biodegradability is very poor.

Syntans are the most widely used re-tanning agents, followed by polyacrylics.

Given the disadvantages mentioned for syntans and polyacrylics, the search is ongoing for re-tanning agents that have a good biodegradability and that are made from preferably renewable starting materials. There continues to be a need for chemical products made from biobased materials instead of petroleum-based materials, and these bio-based materials are thus called renewable materials. There is currently a big driving force for companies, and the chemical industry in particular, for corporate responsibility and the use of sustainable or renewable sources of raw materials.

ISO 105-B02 assesses the light resistance. This method is intended to determine the resistance of the colour of leather to the action of a standard artificial light source. The Xenon lamp has an emission wavelength profile close to daylight; the colour change of the leather is visually assessed with grey scales, with a scale ranging from 5 (best) to 1 (worst). ISO 105-B06 assesses the light resistance at elevated temperature.

COD (chemical oxygen demand) is measured by reacting the oxidizable substance with sulphuric acid and potassium dichromate solution in the presence of silver sulphate as a catalyst. Chloride is masked by mercury sulphate. The value is derived from the intensity of the green colouration of Cr³⁺. The method is according to ISO 15705. A lower COD value, expressed in mg per kg of skin/pelt, is desired. BOD₅ (biological oxygen demand) is the 5-day biochemical oxygen demand, where nitrification is inhibited by 5 mg/L allylthiourea. The dissolved oxygen is analysed in an alkaline solution with a pyrocatechol derivative in the presence of Fe²⁺, under which conditions a red dye is formed which is measured in a photospectrometer. The method is according to EN 1899-1. The ratio BOD₅/COD is calculated from the measured values of COD and BOD₅. A higher BOD₅/COD ratio is seen as better, because this means that the product is better biodegradable.

U.S. Pat. No. 5,074,884 describes the use of certain polyaminoamide resins as auxiliaries for the dyeing of leather in combination with anionic dyeing agents.

EP0316730 describes the use of aliphatic polyamine or polyimine with at least one primary and one secondary amino group in the molecule, with at least amino group in protonated form as auxiliaries for the dyeing of leather.

EP0432686 describes the use of a polyoxyalkylene derivative of a condensation product of certain amines, aromatic alcohols and formaldehyde or paraformaldehyde as auxiliaries for the dyeing of leather.

WO9424361A1 describes the use of certain alkoxylated polyamines and their partial amides with carboxylic acids, in which all or some aminobasic nitrogen atoms may be N-oxides, as leather dyeing auxiliary agents.

JP3267510 describes the use of aqueous cationic polyurethane resins as auxiliaries for the dyeing of leather.

CN107385966 discloses an organosilicon dyeing auxiliary agent for leather, which is actually a small heterocycle with 4 trimethoxysilane groups. A disadvantage of using this material is the release of methanol, which is a toxic component.

CN108034780B describes the use of the reaction product of glycolic acid and the carboxymethyl chitosan as auxiliaries for the dyeing of leather.

EP2714756B1 describes graft polymers of polysaccharides and polypeptides or its respective derivatives, which can be used as tanning agents for leather. The graft polymers are obtained by free radical polymerization of A) a monomer selected from or a monomer mixture of (a) from 20 to 100% by weight of acrylic acid or methacrylic acid or a mixture thereof or of the alkali metal, alkaline earth metal or ammonium salts thereof, (b) from 0 to 80% by weight of other monoethylenically unsaturated monomers which are copolymerizable with the monomers (a) and (c) 0 to 5% by weight of monomers having at least two ethylenically unsaturated non-conjugated double bonds in the molecule in the presence of either B1) polysaccharides or B2) polypeptides in a weight ratio A:(B1 or B2) of from 1:92 to 18:82. The grafting is done with acrylic monomers to obtain a polyacrylate side chain attached to the polysaccharides and polypeptides or its respective derivatives. The acrylic monomers have a petrochemical source and no mention is made of the biodegradability of the effluent.

U.S. Pat. No. 8,227,560B2 describes polycarboxylic acid polymers obtained from vinyl type monomers that may contain pendant carboxylic acid groups and ester type functionality, wherein the number of pendant carboxylic acid groups in the polymer is larger than the number of pendant ester groups, and wherein said polymer material indicates ¹³C NMR triads having a syndiotacticity of greater than 58.0%.

EP2283066B1 describes polycarboxylic acid polymers obtained from vinyl type monomers that may contain pendant carboxylic acid groups and ester type functionality, wherein in the polymer the number of pendant carboxylic acid groups is larger than the number of pendant ester groups, and wherein the neutralization of the carboxylic acid groups is between 45% and 55%, where the neutralization is done prior to the polymerization step.

U.S. Pat. No. 7,910,676B2 describes polycarboxylic acid polymers obtained from vinyl type monomers that may contain pendant carboxylic acid groups and ester type functionality, wherein the number of pendant carboxylic acid groups in the polymer is larger than the number of pendant ester groups, wherein the neutralization of the carboxylic acid groups is between 25% and 85% where the neutralization is done prior to the polymerization step, and wherein at least 50% of the monomer, from three specific types of monomers, has reacted.

U.S. Pat. No. 7,910,677B2 describes the use of polymers from US791067B2 as detergents.

US2014259439A1 describes the use of polycarboxylic acid polymers for the re-tanning of leather, with polycarboxylic acid polymers obtained from vinyl type monomers that may contain pendant carboxylic acid groups and ester type functionality, wherein in the polymer the number of pendant carboxylic acid groups is larger than the number of pendant ester groups, and wherein said polymer has either ¹³C NMR triads having a syndiotacticity of greater than 58.0%; or (2) the weight average molecular weight is of at or above 20,000.

EP2225399B1 describes a re-tanning and fatliquoring agent for leather comprising a composition of two polymers obtained from reacting unsaturated dicarboxylic anhydrides with specific side groups and partially reacted with bisulphite or metabisulphite or sulphite or sulphuric acid or oleum.

Most common dyeing auxiliaries used in the dyeing process of leather as well as most common re-tanning agents are based on chemicals or polymers that find their major sourcing in the petrochemical industry. Leather being a naturally sourced material, there is a great desire to use chemicals and polymers during the leather making process that are obtained from natural and renewable sources. Hence, there is a desire to have, for example dyeing auxiliaries or re-tanning agents that are obtained from natural and renewable sources, while the dyeing performance and re-tanning activity needs to be good as well.

The object of the present invention is to provide a novel compound that is obtained out of natural and renewable source and that may be used in the leather making process, for example as a dyeing auxiliary which employment results in leather that has good dye intensity, dye levelness, tightness, heat resistance, good lightfastness according to ISO105-B02 and/or to ISO105-B06 and a favourable COB₅/COD ratio or as a re-tanning agent which employment results in leather that has good tightness, fullness, superficial touch, dye intensity, dye levelness, tightness, heat resistance, good lightfastness according to ISO105-B02 and/or to ISO105-B06 and a favourable COB₅/COD ratio.

Hence, in a first aspect, the present invention relates to a graft polymer obtainable by polymerizing one or more mono-unsaturated polycarboxylic acids in the presence of naturally occurring polyols and/or naturally occurring polymers.

It has been surprisingly found that using such a graft polymer as a dyeing auxiliary provides dyed leathers that show a better dye intensity, dye levelness and tightness of the obtained leather and a good light resistance, compared with current industry dyeing auxiliary products and that using such a graft polymer as a re-tanning agent provides re-tanned leathers that show a better dye intensity and good tightness, fullness, superficial touch, dye levelness, light resistance and tightness of the obtained leather, compared to current industry re-tanning agents, while the COB₅/COD ratio of the graft polymer is more favourable, e.g. such as higher than 5% or even higher than 10% and preferably higher than 20%, than for these current industry standard dyeing auxiliaries or re-tanning agents.

In a second aspect, the present invention relates to a dyeing auxiliary composition suitable for dyeing leather, hides and/or pelts comprising said graft polymer and optionally a naturally occurring polyol or naturally occurring polymer.

In a third aspect, the present invention relates to a composition suitable for re-tanning leather, hides and/or pelts comprising said graft polymer and optionally a naturally occurring polyol or naturally occurring polymer.

An advantage of the compositions of the present invention is that their components are sourced from biobased origin or can be sourced from biobased origin.

A further advantage of using the compositions of the present invention as dyeing auxiliaries in the treatment of leather is that the light fastness according to ISO 105-B02 and ISO 105-B06 of the leather is high and generally higher than for leathers treated with an industry reference dyeing auxiliary.

A further advantage of using the compositions of the present invention as dyeing auxiliaries in the treatment of leather is that the dye intensity and the dye levelness is good and generally better than for leathers treated with an industry reference dyeing auxiliary.

A further advantage of using the compositions of the present invention as re-tanning agent in the treatment of leather is that the light fastness according to ISO 105-B02 and ISO 105-B06 of the leather is high and generally higher than for leathers treated with an industry reference polyacrylic re-tanning auxiliary.

A further advantage of using the compositions of the present invention as re-tanning agent in the treatment of leather is that the dye intensity, the tightness, fullness and superficial touch is generally better than for leathers treated with an industry reference polyacrylic re-tanning agent.

Tightness is an aesthetic quality parameter, organoleptical characteristic, defined by the amount of wrinkling or creasing when the leather is flexed grain-inwards (by visual assessment), result of a good or bad adherence between the grain layer to the underlying dermis. Fullness is an aesthetic quality parameter, organoleptical characteristic, defined by the spacing between the fibres, suggesting (by the tactile sense) a larger or smaller amount of fibres per area. It is the result of a good filling of the interfibrillar spaces and an adequate lubrication of the fibres avoiding their agglomeration

A further advantage of using the compositions of the present invention is that a higher ratio in BOD₅/COD is achieved, which is seen as better, because this means that compositions are better biodegradable in a wastewater treatment facility.

The polymerizing of one or more mono-unsaturated polycarboxylic acids occurs by a polymerization reaction of the carbon-carbon double bonds of the mono-unsaturated polycarboxylic acids to form a polymer. Besides the one or more mono-unsaturated polycarboxylic acids also other unsaturated monomers may be present. Suitable other unsaturated monomers can be selected from acrylic or methacrylic alkyl esters, optionally functionalized with hydroxy, quaternary amines or halogen groups, acrylonitrile, styrene, esters and ethers of vinyl alcohol. In case that also other unsaturated monomers are present, then the contribution of these other unsaturated monomers is generally small compared to the contribution of the one or more mono-unsaturated polycarboxylic acids, preferably with a (weight) ratio of between 10:90 to 0:100. Preferably acrylic acid or methacrylic acid (or any other mono-unsaturated mono-carboxylic acid) is not used as other unsaturated monomers or at least only in a (weight) ratio of between 10:90 and 0:100. Higher amounts of mono-carboxylic acids would lead to a too low COOH concentration.

Polymerization of the unsaturated monomers may be effected by the use of a radical initiator, as is well known in the industry. Examples of mono-unsaturated polycarboxylic acids, having two or more carboxylic groups, preferably mono-unsaturated dicarboxylic acids for use in the present invention include maleic acid, fumaric acid, glutaconic acid (CAS 110-94-1), 2-decendioic acid (CAS 15790-91-7/334-49-6), traumatic acid (CAS 6402-36-4), itaconic acid (CAS 97-65-4), citraconic acid (CAS 498-23-7), mesaconic acid (CAS 498-24-8), 2-methyl-3-nonylidene-butanedioic acid (CAS 5703-14-0), 2, 3-diethyl-2-butenedioic acid (CAS 13406-97-8), 2-ethyl-3-methyl-2-butenedioic acid (CAS 28098-80-8), 2-ethylidene-3-methyl-butanedioic acid (CAS 28308-39-6), 2-ethyl-3-ethylidene-butanedioic acid (CAS 54369-23-2), 2-(1-hexenyl)-3-methyl-butanedioic acid (CAS 68845-59-0), 2-ethenyl-3-ethyl-butanedioic acid (CAS 87817-18-3), 2-hexylidene-3-methyl-butanedioic acid (CAS 98985-76-3), 2-methyl-3-tetradecyl-2-butenedioic acid (CAS 148796-51-4/150240-40-7/183210-82-4), 2-dodecyl-3-methyl-2-butenedioic acid (CAS 267224-62-4/267641-83-8), 2-ethyl-3-methyl-2-butenedioic acid (CAS 712275-00-8), 2,3-dipropyl-2-butenedioic acid (CAS 929599-31-5), 2-methyl-3-propyl-2-butenedioic acid (CAS 1363041-77-3), 2-ethenyl-3-methyl-butanedioic acid (CAS 1378827-57-6), 2-methyl-3-(1-propen-1-yl)-butanedioic acid (CAS 1379391-88-4), 2-butyl-3-methyl-2-butenedioic acid (CAS 1379422-00-0), 2-hexylidene-3-methyl-butanedioic acid (CAS 1397187-33-5), 2-(1-hexen-1-yl)-3-methyl-butanedioic acid (CAS 1824907-51-8), 2-methyl-3-pentyl-2-butenedioic acid (CAS 2169718-42-5), 2-methyl-3-propyl-2-butenedioic acid (CAS 2307860-29-1), 2-hexyl-3-methyl-2-butenedioic acid (CAS 2307905-18-4), 2-heptylidene-3-methyl-butanedioic acid (CAS 2749001-74-7), 2-methylene-3-(1-methylethyl)-pentanedioic acid (CAS 1459-72-9), 2-methyl-4-methylene-pentanedioic acid (CAS 3290-56-0), 2-methylene-pentanedioic acid (CAS 3621-79-2), 2-methyl-5-methylene-hexanedioic acid (CAS 5363-70-2), 2,2-dimethyl-4-methylene-pentanedioic acid (CAS 10297-25-3), 2-methylene-hexanedioic acid (CAS 32851-84-6), 2-methylene-heptanedioic acid (CAS 33229-02-6), 2,3-dicarboxy-2-propenyl (CAS 63974-74-3), 2,3-dimethyl-4-methylene-pentanedioic acid (CAS 103910-63-0), 2,4-dimethyl-2-hexenedioic acid (CAS 112990-06-4), 2-methyl-2-hexenedioic acid (CAS 116570-75-3), 2,5-dimethyl-2-hexenedioic acid (CAS 860255-90-9), 2-ethyl-4-methylene-pentanedioic acid (CAS 1378837-16-1). Preferred examples of mono-unsaturated polycarboxylic acids include glutaconic acid, itaconic acid, citraconic acid and mesaconic acid. Particularly preferred are itaconic acid, because itaconic acid is a biobased product mainly produced by fermentation using certain filamentous fungi, and citraconic acid and mesaconic acid, which can both be prepared from biobased citric acid.

The naturally occurring polyols or naturally occurring polymers in which presence the polymerizing of one or more mono-unsaturated polycarboxylic acids occurs to obtain the graft polymer of the invention are biobased molecules with multiple hydroxyl groups or are biobased polymers with hydroxyl functionalities. Examples of suitable biobased molecules with multiple hydroxyl groups are monosaccharides, such as erythrose, threose, ribose, arabinoase, xylose, lyxose, allose, altrose, glucose, mannose, gulose, idose, galactose, talose, erythrulose, ribulose, xylulose, psicose, fructose, sorbose, tagatose, pyrosides, disaccharides, such as sucrose, lactose, maltose, trehalose, cellobiose, chitobiose, kojibiose, nigerose, isomaltose, sophorose, laminasribiose, gentiobiose, trehalulose, turanose, maltulose, leucrose, isomaltose, gentiobiulose, mannobiose, melibiose, melibiulose, rutinose, rutinulose, xylobiose, and sugar alcohols, such as glycerol, eythritol, threitol, arabitol, xylitol, ribitol, mannitol, sorbitol, galactitol, fucitol, iditol, inositol, volemitol, isomalt, maltitol, lactitol. Also mixtures of biobased molecules with multiple hydroxyl groups can be used, or mixtures of biobased polymers with hydroxyl functionalities or mixtures of biobased molecules with multiple hydroxyl groups and biobased polymers with hydroxyl functionalities can be used. Preferred examples of biobased molecules with multiple hydroxyl groups are sugar alcohols like glycerol and sorbitol. Examples of biobased polymers with hydroxyl functionalities are polynucleotides, polypeptides, polysaccharides, lignin, cutin, cutan, melanin and oligosaccharides. Examples from the group of polysaccharides, which are linear or branched polymeric carbohydrates, are amylose, starch, glycogen, galactogen, inulin, pectin, cellulose and alginate, and also include derivatives from linear or branched polymeric carbohydrates such as hydrolyzed starch or alkylated starch or functionalized starch or hydrolyzed cellulose or alkylated cellulose or functionalized cellulose. Examples from the group of oligosaccharides are maltodextrins, raffinose, stachyose, fructosaccharide. Examples from the group of polypeptides are casein and whey protein. Preferred examples of biobased polymers with hydroxyl functionalities are starch, glycogen, casein and whey.

Preferred weight ratios in the graft polymer between the one or more mono-unsaturated polycarboxylic acids and the one or more naturally occurring polyols or naturally occurring polymers are between 10 and 500 parts of the one or more mono-unsaturated polycarboxylic acids to 100 parts of the one or more naturally occurring polyols or polymers, wherein the parts are referring to the mass of the non-volatile components therein. More preferably, the weight ratio between the one or more mono-unsaturated polycarboxylic acids and the one or more naturally occurring polyols or naturally occurring polymers is between 100 and 400 parts of the one or more mono-unsaturated polycarboxylic acids to 100 parts of the one or more naturally occurring polyols or polymers wherein the parts are referring to the mass of the non-volatile components therein. In the context of the present invention, non-volatile components are those components that do not evaporate into air due to their low vapour pressure and that can be defined as any component that has an initial boiling point above 250° C. measured at a standard pressure of 101.3 kPa.

Preferably, the amount of the one or more mono-unsaturated polycarboxylic acids employed to prepare the graft polymer composition, as defined below, contributes between 5 and 90 weight %, preferably between 8 and 70 weight %, on the total graft polymer composition considering only the non-volatile components therein.

Preferably, the amount of the one or more naturally occurring polyols or naturally occurring polymers employed to prepare the graft polymer composition contributes between 5 and 90 weight %, preferably between 10 and 85 weight %, on the total graft polymer composition considering only the non-volatile components therein.

Radical initiators are substances that can produce radical species under mild conditions and promote radical reactions. They generally possess bonds that have small bond dissociation energies. Typical examples are molecules with a nitrogen-halogen bond, azo compounds, organic and inorganic peroxides and peroxydisulphate salts. A preferred type of radical initiator is the group of peroxydisulphate salts, in particular sodium persulphate (Na₂S₂O₈), potassium persulphate (K₂S₂O₈), and ammonium persulphate ((NH₄)₂S₂O₈) as these salts are water-soluble solids, providing colourless solutions. In solution, at the reaction conditions, peroxydisulphate dissociates to give sulphate radicals.

Preferably graft polymers of the present invention are water soluble or water dispersible.

For the preparation of the graft polymers, the one or more mono-unsaturated polycarboxylic acids and optionally copolymerizable other monomers are advantageously subjected to free radical polymerization in the presence of naturally occurring polyols or naturally occurring polymers. In some cases, it may be advantageous for the action of the resulting graft polymer to use two or more of the naturally occurring polyols or two or more of the naturally occurring polymers or a mixture of naturally occurring polyols and naturally occurring polymers. The polymerization can be carried out in the presence or absence of inert solvents or inert diluents. Inert solvents or inert diluents in which the naturally occurring polyols or naturally occurring polymers can be suspended and which dissolve the mono-unsaturated polycarboxylic acid monomers are suitable. A particularly preferred inert solvent is water.

A preferred method for the preparation of the graft polymers is solution polymerization, the ingredients and the resulting graft copolymer being present at least in dispersed form and in many cases in dissolved form. For example, inert solvents such as water, methanol, ethanol, isopropanol, n-propanol, n-butanol, sec-butanol, tetrahydrofuran, dioxane and mixtures thereof, are suitable for the solution polymerization.

The polymerization is typically carried out batchwise.

The graft polymers described which are preferably water-soluble are generally prepared in the presence of free radical initiators for example inorganic and organic peroxides, persulphates, azo compounds and redox catalysts. Water-soluble and water-insoluble free radical initiators or mixtures of water-soluble and water-insoluble free radical initiators may be used. The water-insoluble free radical initiators are then soluble in the organic phase.

The polymerization of the monomers can also be carried out by the action of ultraviolet radiation, in the presence or absence of the UV initiators. For polymerization under the action of UV radiation, the conventional photoinitiators or sensitizers are used. These are, for example, compounds such as benzoin and benzoin ethers, tx-methylbenzoin and a-phenylbenzoin. Triplet sensitizers, such as benzyl diketals, can also be used. The UV radiation sources in addition to high-energy UV lamps, such as carbon arc lamps, mercury vapor lamps or xenon lamps are, for example, low-UV light sources, such as fluorescent tubes having a high blue component.

A polymerisation regulator can be used in the graft polymerisation process to regulate the side chain lengths as required. Any compound containing active hydrogen can be used as chain transferring agent. Examples of suitable regulators are mercapto compounds, such as mercapto alcohols, mercapto acids or mercapto esters. Other suitable regulators including allyl alcohols, aldehydes, formic acid, amines or their salts. If needed from 0.05-10% by weight, based on the quantity of mono-unsaturated polycarboxylic acids can be used.

The other grafting polymerisation conditions will follow the usual procedure for such process. The polymerisation system is preferably placed an inert gas atmosphere in the absence of atmosphere oxygen.

Preferably subsequent to the polymerisation step, and not prior to it, the acidic groups of the obtained polymer are neutralized by the addition of a base, which may be a mineral base or an organic base. However the acidic groups of the monomers may also be neutralized before the polymerization step wherein the neutralization of the carboxylic acid groups is between 60% and 75%. The neutralization is preferably done so that the pH of the obtained mixture reaches a value of between 4 and 7, which effectively means that a neutralization degree of about 55% to 75% is achieved. Mixing may take place at ambient temperatures, i.e. between about 10° C. and 40° C. and may use all kinds of available equipment.

The graft polymers which can be prepared by the above mentioned processes are colourless to brownish products. In the case of polymerization in an aqueous medium, they are in the form of dispersions or polymer solutions. Depending on the particular composition or concentration of the graft polymers, the products are low-viscosity to pasty aqueous solutions or dispersions. Owing to the content of natural substances, the graft polymers described above are more readily biodegradable than the polymers used to date and based on ethylenically unsaturated monomers but can at least be eliminated from the wastewater of wastewater treatment plants with the sewage sludge.

The aqueous graft polymer solutions or dispersion, also referred to herein as the graft polymer composition obtained according to the process of the present invention may be directly applied in the production of leather and skins. However, they may also contain further additives and also may be with or without further additives be dried, for instance by spray drying.

Further additives may be added to the liquid, and when drying is applied then these further additives may be added prior to or after the drying step. All the compounds commonly used in leather processing can be added. Typically including the following: biocides, inorganic fillers such as china clay, kaolin of other similar alum-silicates; organic compounds such as (poly)saccharides and polypeptides mentioned above, lignin and its derivatives, vegetable tannings, amino-resins and synthetic tannins; silicon oxide and derivatives such as silica and water glass; fatty materials, natural or synthetic, solubilized using any suitable functional groups.

The graft polymer as such or graft polymer composition thus obtainable are very suitable in the production of leather and skins, in particular as dyeing auxiliary or re-tanning agent. They can be used as such or in a suitable composition containing other additives.

When used as a dyeing auxiliary or as a re-tanning agent, the graft polymer composition is preferably liquid at ambient conditions.

The graft polymer composition is generally a solution in water or a dispersion in water.

The graft polymer composition may contain one or more water-miscible organic solvents and/or one or more plasticizers of in total up to 30% by weight of the overall weight of the composition.

Preferably, the water-miscible organic solvent is selected from the group consisting of monohydric alcohols, polyhydric alcohols, ethers and ethers of polyhydric alcohols, ketones, esters of organic acids and aromatic solvents. Preferably, the ester of organic acids is selected from the group consisting of ethyllactate, dimethyl carbonate, propylene carbonate. Preferably, the polyhydric alcohol is selected from the group consisting of ethylene glycol monoethyl ether, ethylene glycol monobutyl ether, diethylene glycol monomethyl ether, diethylene glycol monoethyl ether, diethylene glycol monobutyl ether, dipropylene glycol dimethyl ether, butyltriglycol and 1-methoxy-2-propanol. More preferably, the water-miscible organic solvent is selected from the group consisting of ethanol, isopropyl alcohol, n-butanol, benzyl alcohol, butyltriglycol, acetone, ethyl methyl ketone, butyl acetate, diethylene glycol monobutyl ether, dipropylene glycol dimethyl ether and 1-methoxy-2-propanol, or mixtures thereof. The amount of water-miscible organic solvent, when present, is generally between 5 and 60 wt % on total dyeing composition.

The graft polymer composition may contain one or more dispersing agents, which are added to improve the separation of particles and to prevent settling or clumping, of up to 5% by weight of the overall weight of the composition. The dispersing agent is preferably selected from the group consisting of surfactants, anti-agglomeration agents, deflocculants, anti-settling agent, polymeric dispersants, and more preferably the dispersing agent is selected from the group consisting of sodium polycarboxylate in aqueous solution. The amount of dispersing agent, when present, is generally between 0.5 and 3 wt % on total graft polymer composition.

In a further aspect, the present invention relates to the use of said graft polymer or graft polymer composition for dyeing or re-tanning of leather, pelts, skins, hides, leather intermediate products or non-finished leather. Most preferably the graft polymer (composition) is used for dyeing or re-tanning of leather, leather intermediate products or non-finished leather.

The graft polymer (compositions) of the present invention can be used to prepare leathers for all applications, for example shoe, furniture, car, clothing and bag leathers.

Any kind of leather which is conventionally dyed or re-tanned is suitable to be dyed or re-tanned by using a graft polymer (composition) of the present invention, particularly grain leather (e.g. nappa from sheep, goat or cow and box-leather from calf or cow), suede leather (e.g. velours from sheep, goat or calf and hunting leather), split velours (e.g. from cow or calf skin), buckskin and nubuck leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned, synthetic organic reactive tanning or semi-chrome tanned). If desired, for the use of a graft polymer composition as a dyeing auxiliary, the leather may also be re-tanned; for re-tanning there may be used any tanning agent conventionally employed for re-tanning, e.g. mineral, vegetable or synthetic tanning agents [e.g. chromium, zirconyl or aluminium derivatives, quebracho, chestnut or mimosa extracts, aromatic syntans, polyurethanes, (co)polymers of (meth)acrylic acid compounds or melamine/dicyandiamide and/or urea/formaldehyde resins]. Thus, leathers of very high to very low affinity for anionic dyes may be used.

The leathers can be of various thicknesses, thus, thin leathers, suitable for garment leather or glove-leather (nappa), leather of medium thickness suitable for shoe upper leather and handbags, or also thick leathers suitable for shoe-sole leather, furniture leather, automotive leather, leather for suitcases, for belts and for sport articles; hair-bearing leathers and furs may also be used.

The leather dyed using the graft polymer (compositions) of the present invention is notable for a good dye intensity, dye levelness, dye penetration and tightness of the leather as evaluated by visual or haptic assessment.

Furthermore, the leather dyed using graft polymer (compositions) of the present invention has a good light resistance according to ISO 105-B02 (IUF 402) and ISO 105-B06 and a good heat resistance as assessed by evaluating the colour change upon storage of leather specimens in an oven at 80° C. for a duration of 8 hours, 48 hours or 168 hours.

The leather re-tanned using the graft polymer (compositions) of the present invention has a good light fastness according to ISO 105-B02 and ISO 105-B06 and generally better than for leathers treated with an industry reference polyacrylic re-tanning auxiliary.

The leather re-tanned using the graft polymer (compositions) of the present invention provides a dye intensity, tightness and superficial touch that is generally better than for leathers treated with an industry reference polyacrylic re-tanning agent.

A higher ratio in BOD₅/COD is achieved for the graft polymer (compositions) of the present invention compared to the industry standard products, which is seen as better, because this means that compositions are biodegradable in a wastewater treatment facility.

The present invention will be further elaborated by the following non-limiting working examples. Parts and percentages of components referred to in these working examples are drawn to the weight of the total composition wherein these components are present, like in the other parts of the description and claims, unless otherwise indicated.

### EXAMPLE 1

An amount of 76 g of demineralized water and 216 g of Example 6 was mixed in a reaction vessel at 25° C. for 10 minutes. While stirring, an amount of 260 g of itaconic acid powder (2.0 moles) was slowly added. A flow of nitrogen gas was applied over the reaction mass. The reaction mixture was heated to 95° C., while stirring. The reaction mixture became transparent. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of 30% aqueous sodium hydroxide (2.4 moles) was added slowly, while the mixture was stirred and cooled with an external ice bath to keep the temperature of the mixture below 40° C. The resulting mixture had a pH value between 4.0 and 5.0 and a non-volatile content in the range from 42.5% to 44.5%.

### EXAMPLE 2

To an amount of 300 g of demineralized water in a reaction vessel at 25° C., was slowly added, while stirring, an amount of 30 g of sulfuric acid sol. 98%. A flow of nitrogen gas was applied over the reaction mass. The reaction mixture was heated to 90° C., while stirring. While stirring, an amount of 198 g of rice starch powder (humidity=10.3%) was slowly added in a period of 30 minutes. Stirring was continued and the starch became fully dissolved after about 3 hours. The colour was now brownish. The mixture was cooled to 85° C., followed by the addition of 72 g of 30% aqueous sodium hydroxide during 15 minutes. The mixture was cooled to 25° C. The molecular weight determined by GPC was 3000 Da, versus a polystyrene standard.

Next, while stirring, an amount of 23 g of itaconic acid powder (0.18 moles) was slowly added. A flow of nitrogen gas was applied over the reaction mass. The reaction mixture was heated to 95° C., while stirring. Next, a mixture of 2.28 g of ammonium persulphate in 18 g of demineralized water was slowly added to the mixture during a period of 4 hours. Stirring of the mixture was continued for 1 hour, followed by cooling the mixture to 35° C. Next, an amount of 45.20 g of 30% aqueous sodium hydroxide (0.34 moles) was added slowly, while the mixture was stirred and cooled with an external ice bath to keep the temperature of the mixture below 40° C. An amount of 1.5 g of a 20% aqueous solution of biocide BIT (benzisothiazolinone) was added to the resulting mixture. And then it had a pH value between 5.0 and 6.0 and a non-volatile content in the range from 38% to 40%.

### EXAMPLE 3

To an amount of 300 g of demineralized water in a reaction vessel at 25° C., was slowly added, while stirring, an amount of 30 g of sulfuric acid sol. 98%. A flow of nitrogen gas was applied over the reaction mass. The reaction mixture was heated to 90° C., while stirring. While stirring, an amount of 198 g of rice starch powder (humidity=10.3%) was slowly added in a period of 30 minutes. Stirring was continued and the starch became fully dissolved after about 3 hours. The colour was now brownish. The mixture was cooled to 85° C., followed by the addition of 72 g of 30% aqueous sodium hydroxide during 15 minutes. The mixture was cooled to 25° C. The molecular weight determined by GPC was 3000 Da, versus a polystyrene standard.

Next, while stirring, an amount of 20.7 g of maleic acid powder (0.18 moles) was slowly added. A flow of nitrogen gas was applied over the reaction mass. Next, an amount of 45.2 g of 30% aqueous sodium hydroxide (0.34 moles) was added slowly, while the mixture was stirred and cooled with an external ice bath to keep the temperature of the mixture below 40° C. The reaction mixture was heated to 70° C., while stirring and kept at 70° C. for 15 minutes. Next the reaction mixture was heated to 95-100° C., The reaction mixture became transparent. An amount of 2.28 g of ammonium persulphate in 18 g of water was added. Stirring of the mixture was continued for 1 hour at 95-100° C., followed by cooling the mixture to 35° C. And then it had a pH value between 5.5 and 6.5 and a non-volatile content in the range from 38% to 40%.

### EXAMPLE 4

To an amount of 200 g of demineralized water in a reaction vessel at 25° C., was slowly added, while stirring, an amount of 260 g of itaconic acid powder (2.0 moles). A flow of nitrogen gas was applied over the reaction mass. The reaction mixture was heated to 95° C., while stirring. The reaction mixture became transparent. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of 30% aqueous sodium hydroxide (2.4 moles) was added slowly, while the mixture was stirred and cooled with an external ice batch to keep the temperature of the mixture below 40° C. The resulting mixture had a pH value in the range 4.5-5.5 and a non-volatile content in the range from 38% to 42%.

### EXAMPLE 5

An amount of 500 g of product prepared according to Example 4 was heated up to 35-40° C., then 111.4 g of Example 6 were added slowly within 10 minutes under stirring to avoid lumps formation. The mixture was stirred for 10-15 minutes.

The resulting mixture had a pH value between 4.0 and 5.0 and a non-volatile content in the range from 38% to 40%.

### EXAMPLE 6: ONLY NATURALLY POLYMER

To an amount of 600 g of demineralized water in a reaction vessel at 25° C., was slowly added, while stirring, an amount of 60 g of sulfuric acid sol. 98%. A flow of nitrogen gas was applied over the reaction mass. The reaction mixture was heated to 90° C., while stirring. While stirring, an amount of 396 g of rice starch powder (humidity=10.3%) was slowly added in a period of 30 minutes. Stirring was continued and the starch became fully dissolved after about 3 hours. The colour was now brownish. The mixture was cooled to 85° C., followed by the addition of 144 g of 30% aqueous sodium hydroxide during 15 minutes. The mixture was cooled to 35° C. The resulting mixture had a pH value of 5.0 to 6.0 and a non-volatile content in the range from 39% to 41%. The molecular weight determined by GPC was 3000 Da, versus a polystyrene standard.

### EXAMPLE 7

An amount of 200 g of demineralized water and 92 g of whey powder was mixed in a reaction vessel at 25° C. for 10 minutes. While stirring, an amount of 260 g of itaconic acid powder (2.0 moles) was slowly added. A flow of nitrogen gas was applied over the reaction mass. The reaction mixture was heated to 95° C., while stirring. The reaction mixture became transparent. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of 30% aqueous sodium hydroxide (2.4 moles) was added slowly, while the mixture was stirred and cooled with an external ice bath to keep the temperature of the mixture below 40° C. The resulting mixture had a pH value between 5.0 and 5.5 and a non-volatile content in the range from 43% to 45%.

### EXAMPLE 8

An amount of 420 g of demineralized water and 180 g of whey powder was mixed in a reaction vessel at 25° C. for 10 minutes. While stirring, an amount of 20.7 g of maleic acid powder (0.18 moles) was slowly added. A flow of nitrogen gas was applied over the reaction mass. Next, an amount of 45.2 g of 30% aqueous sodium hydroxide (0.34 moles) was added slowly, while the mixture was stirred and cooled with an external ice bath to keep the temperature of the mixture below 40° C. The reaction mixture was heated to 70° C., while stirring and kept at 70° C. for 15 minutes. Next the reaction mixture was heated to 95-100° C., The reaction mixture became transparent. An amount of 2.28 g of ammonium persulphate in 18 g of water was added. Stirring of the mixture was continued for 1 hour at 95-100° C., followed by cooling the mixture to 35° C. The resulting mixture had a pH value between 5.5 and 6.5 and a non-volatile content in the range from 30% to 35%.

### EXAMPLE 9

An amount of 500 g of product prepared according to Example 4 was heated up to 35-40° C., then 47.5 g of whey powder were added slowly within 10 minutes under stirring to avoid lumps formation. The mixture was stirred for 10-15 minutes until complete dissolution of whey powder.

The resulting mixture had a pH value between 4.0 and 5.0 and a non-volatile content in the range from 43.5% to 45.5%.

### EXAMPLE 10

An amount of 700 g of demineralized water and 300 g of whey powder was mixed in a reaction vessel at 25° C. for 15-20 minutes. The resulting mixture had a pH value between 5.5 and 6.5 and a non-volatile content in the range from 29% to 31%.

### EXAMPLE 11

An amount of 200 g of demineralized water and 92 g of glycerol was mixed in a reaction vessel at 25° C. for 10 minutes. While stirring, an amount of 260 g of itaconic acid powder (2.0 moles) was slowly added. A flow of nitrogen gas was applied over the reaction mass. The reaction mixture was heated to 95° C., while stirring. The reaction mixture became transparent. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of 30% aqueous sodium hydroxide (2.4 moles) was added slowly, while the mixture was stirred and cooled with an external ice bath to keep the temperature of the mixture below 40° C. The resulting mixture had a pH value between 5.0 and 5.5 and a non-volatile content of 43% to 45%.

Syndiotacticity was measured using a Bruker Advance 400 MHz NMR machine. The sample was dissolved in D₂O prepared with a concentration of about 0.25 g/g. The solution was then transferred in a 5 mm diameter NMR tube and pH was adjusted to about 1.0-1.5 with 12N of hydrochloric acid. ¹³C NMR spectra were recorded with a 90° pulse angle, 25 s delay between pulses and 3000 accumulations, with T=30° C. Signals of interest relative to the carbonyl moieties were integrated for the calculation of the syndiotacticity degree. Tacticity was determined from the chemical shift of the rr, mr and mm triads, as the ratio between the integral of rr triad over the sum of the integrals of all triads (rr+mr+mm). More specifically, the peak of rr triad was at about 178.7 ppm, the peak of mr triad was at about 178.2 ppm and the peak of mm triad was at about 177.6 ppm. The ratio of the integrated signals indicated a syndiotacticity degree of 55%.

### EXAMPLE 12

An amount of 500 g of product prepared according to Example 4 was heated up to 35-40° C., then 47.5 g of glycerol were added slowly within 10 minutes under stirring to avoid lumps formation. The mixture was stirred for 10-15 minutes.

The resulting mixture had a pH value between 4.0 and 5.0 and a non-volatile content in the range from 43.5% to 45.5%.

### EXAMPLE 13

To an amount of 600 g of demineralized water in a reaction vessel at 25° C., was slowly added, while stirring, an amount of 60 g of an aqueous solution of 98% of sulfuric acid. A flow of nitrogen gas over the reaction mass was applied. The reaction mixture was heated to 90° C., while stirring. While stirring, an amount of 396 g of Hydroxyethyl cellulose powder (Natrosol 250 HBR; obtainable from Ashland Inc) was slowly added in a period of 30 minutes. Stirring was continued and the starch became fully dissolved after about 3 hours. The colour was now brownish. The mixture was cooled to 85° C., followed by the addition of 144 g of an aqueous solution of 30% sodium hydroxide during 15 minutes. The mixture was cooled to 35° C. The resulting intermediate mixture had a pH value of 5.0 to 6.0.

Of this intermediate mixture, an amount of 216 g was mixed with 76 g of demineralized water in a reaction vessel at 25° C. for 10 minutes. While stirring, an amount of 260 g of itaconic acid powder (2.0 moles) was slowly added. A flow of nitrogen gas was applied over the reaction mass. The reaction mixture was heated to 95° C., while stirring. The reaction mixture became transparent. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of 30% aqueous sodium hydroxide (2.4 moles) was added slowly, while the mixture was stirred and cooled with an external ice bath to keep the temperature of the mixture below 40° C.

The resulting mixture had a pH value between 4.0 and 5.0 and a non-volatile content in the range from 42.5% to 44.5%.

### EXAMPLE 14

To an amount of 287 g of demineralized water in a reaction vessel at 25° C., was slowly added, while stirring, an amount of 15 g of an aqueous solution of 98% of sulfuric acid. A flow of nitrogen gas over the reaction mass was applied. The reaction mixture was heated to 90° C., while stirring. While stirring, an amount of 143.5 g of carboxymethyl starch powder (with a humidity of 10%) was slowly added in a period of 30 minutes. Stirring was continued and the powder became fully dissolved after about 1 hour. The colour was now orange. The mixture was cooled to 85° C., followed by the addition of 38.5 g of a 30% solution of aqueous sodium hydroxide during 15 minutes. The colour now became yellow. A flow of nitrogen gas over the solution was applied and an amount of 6.3 g of a 30% solution of aqueous hydrogen peroxide was added slowly, during 4 hours, while keeping the temperature at about 95° C. An exothermic reaction occurred. Next, the mixture was cooled to 70° C., followed by the addition of a mixture of 3.5 g of urea in 17 g of demineralized water, followed by continued stirring for 15 minutes. The mixture was cooled to 35° C. The resulting mixture had a pH value of 4.0 to 5.0 and a non-volatile content of 29% to 31%. This is called ‘Intermediate I’. The molecular weight determined by GPC was 3000 Da, versus a polystyrene standard.

An amount of 316 g of the above Intermediate I mixture was added in a reaction vessel at 25° C. While stirring, an amount of 260 g of itaconic acid powder (2.0 moles) was slowly added. A flow of nitrogen gas over the reaction mass was applied. The reaction mixture was heated to 95° C., while stirring. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of a 30% aqueous solution of sodium hydroxide (2.4 moles) was added slowly, while the mixture was stirred and cooled with an external ice bath to keep the temperature of the mixture below 40° C. Next an amount of 4427 g of the Intermediate I was added. The resulting mixture had a pH value between 4.0 and 5.0 and a non-volatile content in the range from 31.0% to 33.0%.

### EXAMPLE 15

An amount of 200 g of demineralized water and 92 g of sucrose was mixed in a reaction vessel at 25° C. for 10 minutes. While stirring, an amount of 260 g of itaconic acid powder (2.0 moles) was slowly added. A flow of nitrogen gas was applied over the reaction mass. The reaction mixture was heated to 95° C., while stirring. The reaction mixture became transparent. An amount of 12 g of sodium persulphate was added. Next, a mixture of 60 g of sodium persulphate in 120 g of demineralized water was slowly added to the mixture during a period of 5 hours. Stirring of the mixture was continued for 1 hour, followed by cooling the mixture to 35° C. Next, an amount of 320 g of aqueous solution of 30% of sodium hydroxide (2.4 moles) was added slowly, while the mixture was stirred and cooled with an external ice bath to keep the temperature of the mixture below 40° C. The resulting mixture had a pH value between 5.0 and 5.5 and a non-volatile content in the range from 43% to 45%.

### EXAMPLE 16

Product was prepared following instruction of Example XVII of US2014/0259439 A1, but adding more water. The mixture had a pH value between 4.0 and 5.0 and a non-volatile content in the range from 34.0% to 35.0%.

To an amount of 140 g of demineralized water in a reaction vessel at 25° C., was slowly added, while stirring, an amount of 100 g of itaconic acid powder (0.77 moles). Next, an amount of 102.5 g of 30% aqueous sodium hydroxide (0.77 moles) was added slowly, while the mixture was stirred and cooled with an external ice bath to keep the temperature of the mixture below 40° C. The reaction mixture was heated to 70° C., while stirring and kept for 15 minutes. The reaction mixture became transparent. The reaction mixture was heated to 100° C. and then an amount of 11.6 g of TBHP (t-butyl hydro peroxide) 70% and 10 g of water were added. Stirring of the mixture was continued for 2 hours at 100° C., followed by cooling the mixture to 35° C. The resulting mixture had a pH value between 4.0 and 5.0 and a non-volatile content in the range from 34.0% to 35.0%.

### EXAMPLE 17: BOD₅ AND COD

The COD (chemical oxygen demand) and BOD₅ (biological oxygen demand in 5 days) were measured of the various compositions included in Table 1. COD was measured according to ISO 15705. A lower COD value, expressed in mg per kg of skin/pelt, is better. BOD₅ was measured according to EN 1899-1. The ratio BOD₅/COD was calculated from the measured values of COD and BOD₅. A higher BOD₅/COD ratio is seen as better, because this means that the product is better biodegradable.

The BOD₅/COD ratios of the compositions from Examples 1 to 16 were notably higher than the BOD₅/COD ratios of reference products Tamol M and Tergotan PR.

The results are collected in Table 1, under Example 19.

### EXAMPLE 18: DYEING LEATHER IN DRUM PROCESS

The compositions obtained from Examples 1 to 16 were used, as well as Tergotan PR and Tanicor M (both obtainable from Stahl Europe BV), which is a current industry dyeing auxiliary product. A full drum process was done starting from Wet Blue leather tanned with chrome, following below described process.

The percentages are the weight percentages referred to the weight of the shaved leather. The shave thickness was 1.1 mm.

At first the leathers were wetted back. An amount of 200% water of 30° C., 0.5% of acetic acid and 0.5% of Tergolix CA Liq (cationic degreasing and emulsifying agent; obtainable from Stahl Europe BV) was added into the drum containing the tanned leathers, and the drum was run for 30 minutes, followed by draining the bath. Next, 100% of water of 30° C. and 2% of sodium formate was added and the drum was run for 20 minutes. Next, 1.2% of sodium bicarbonate was added, after which the drum was run for 40 minutes, pH was 5.5, flowing by draining the drum. The leather in the drum was subsequently washed with water of 30° C. and the drum was drained.

An amount of 100% water at 40° C. was added and next 3% of Derminol CFS liq. (obtainable from Stahl Europe BV) was added and the drum was run for 30 minutes. Next, 3% of Tergotan PR (obtainable from Stahl Europe BV) was added and the drum was run for 30 minutes, followed by the addition of 3% Granofin TA powder (vegetable tanning agent; obtainable from Stahl Europe BV) and 4% of Basyntan DLE powder (obtainable from Stahl Europe BV). The drum was run for 60 minutes, followed by the addition of 0.5% of an aqueous solution of 85% of formic acid, after which the drum was run for 60 minutes and then drained.

An amount of 200% of water was added and the drum was run for 20 minutes, followed by draining the drum. An amount of 150% of water of 40° C. was added together with 2% of Tamol Nl liq (obtainable from Stahl Europe BV) and the drum was run for 30 minutes. Next, an amount of 2% of of graft polymer composition was added and the drum was run for 30 minutes.

In the next step, dyeing was achieved by adding 0.35% of Melioderm HF Navy RB (a dye powder in colour blue, obtainable from Stahl Europe BV), 0.50% of Melioderm Black AF 135 (a dye powder in colour black, obtainable from Stahl Europe BV) and 1.50% of Melioderm HF Dark Brown R (a dye powder in colour brown, obtainable from Stahl Europe BV) and running the drum for 60 minutes, followed by the addition of 0.5% of an aqueous solution of 85% of formic acid and running the drum for 30 minutes, followed by draining the liquid. The leather was washed, dried by hanging and conditioned.

### EXAMPLE 19: TESTING OF OBTAINED LEATHER

Specimens from the obtained leather from Example 18 were evaluated on light fastness according to ISO 105-B02 and ISO 105-B06, on heat resistance, dye intensity, dye levelness, dye penetration.

ISO 105-B02 (IUF 402) assesses the light resistance. This method is intended for determining the resistance of the colour of leather to the action of a standard artificial light source. The Xenon lamp has an emission wavelength profile close to daylight; the colour change of the leather is visually assessed with grey scales, with a scale ranging from 5 (best) to 1 (worst).

ISO 105-B06 assesses the light resistance at elevated temperature. This method is intended for determining the resistance of the colour of leather to the action of a standard artificial light source. The Xenon lamp has an emission wavelength profile close to daylight; the colour change of the leather is visually assessed with grey scales, with a scale ranging from 5 (best) to 1 (worst).

Heat resistance was assessed by placing leather specimens in an oven at 80° C. for a duration of 8 hours, 48 hours or 168 hours. The longer duration represents a more harsh testing condition. The change in colour of the leather are assessed with standard Grey scale, with a scale ranging from 5 (best) to 1 (worst).

Dye intensity, dye levelness and dye penetration of the leather were evaluated by visual or haptic assessment, rated with standard Grey scale, with a scale ranging from 5 (best) to 1 (worst).

The scores of all the grey scale ratings were summed to allow an easy comparison over such a variety of properties.

The results are collected in Table 1.

TABLE 1
Properties of leather upon treatment with various dyeing auxiliaries,
and BOD₅/COD results of the various compositions.

| | 1 | 2 | 3 | 4 | 5 | 6 | 7 |
|---|---|---|---|---|---|---|---|
| Itaconic/ | I | I | M | I | I | | I |
| Maleic | | | | | | | |
| Starch/Carboxy | S | S | S | | S | S | W |
| MethylStarch/ | | | | | | | |
| Whey/Glycerol/ | | | | | | | |
| Hydroxyethyl | | | | | | | |
| Cellulose/ | | | | | | | |
| SAccharose | | | | | | | |
| Innovative/Ref/ | I | I | I | C | C | C | I |
| Comp | | | | | | | |
| Dye intensity | 4 | 5 | 5 | 3 | 3 | 5 | 3 |
| Dye levelness | 4 | 2 | 4 | 3 | 3 | 1 | 3 |
| Dye | 2 | 2 | 1 | 3 | 3 | 1 | 3 |
| penetration | | | | | | | |
| ISO 105-B06 | 2½ | 3½ | 2 | 2.5 | 1½ | 3 | 1½ |
| ISO 105-B02 | 4 | 4½ | 4 | 3 | 3 | 4½ | 3½ |
| 8 h/100° C. | 4 | 3½ | 3½ | 4½ | 3½ | 4 | 4 |
| 48 h/100° C. | 4 | 3 | 3½ | 4 | 3½ | 4 | 4 |
| 168 h/100° C. | 4 | 3 | 3½ | 3½ | 3 | 3½ | 4 |
| Sum of scores | 28½ | 26½ | 26½ | 26½ | 23½ | 26 | 26 |
| COD | 422311 | 365892 | 371658 | 443541 | 344852 | 349696 | 461880 |
| BOD | 27750 | 155838 | 147216 | 17298 | 31759 | 166530 | 44500 |
| ratio BOD/COD | 6.6% | 42.6% | 39.6% | 3.9% | 9.2% | 47.6% | 9.6% |

| | 8 | 9 | 10 | 11 | 12 | 13 |
|---|---|---|---|---|---|---|
| Itaconic/ | M | I | | I | I | I |
| Maleic | | | | | | |
| Starch/Carboxy | W | W | W | G | G | HC |
| MethylStarch/ | | | | | | |
| Whey/Glycerol/ | | | | | | |
| Hydroxyethyl | | | | | | |
| Cellulose/ | | | | | | |
| SAccharose | | | | | | |
| Innovative/Ref/ | I | C | C | I | C | I |
| Comp | | | | | | |
| Dye intensity | 5 | 3 | 5 | 3 | 2 | 4 |
| Dye levelness | 4 | 2 | 1 | 5 | 2 | 2 |
| Dye | 1 | 3 | 1 | 3 | 2 | 4 |
| penetration | | | | | | |
| ISO 105-B06 | 2½ | 1½ | 4 | 2¾ | 2¼ | 2½ |
| ISO 105-B02 | 4 | 2½ | 4 | 2½ | 2½ | 3 |
| 8 h/100° C. | 3 | 3½ | 4 | 4¾ | 4½ | 5 |
| 48 h/100° C. | 3 | 3½ | 3½ | 4¾ | 4½ | 5 |
| 168 h/100° C. | 3 | 3½ | 3½ | 4 | 3½ | 4½ |
| Sum of scores | 25½ | 22½ | 26 | 29¾ | 23¼ | 30 |
| COD | 347421 | 470758 | 334850 | 466790 | 473860 | 297462 |
| BOD | 41524 | 66100 | 33200 | 57600 | 166100 | 41614 |
| ratio BOD/COD | 12.0% | 14.0% | 9.9% | 12.3% | 35.1% | 14.0% |

| | | | | | Tergotan |
|---|---|---|---|---|---|
| | 14 | 15 | 16 | TanicorM | PR |
| Itaconic/ | I | I | I | | |
| Maleic | | | | | |
| Starch/Carboxy | CMS | SA | | | |
| MethylStarch/ | | | | | |
| Whey/Glycerol/ | | | | | |
| Hydroxyethyl | | | | | |
| Cellulose/ | | | | | |
| SAccharose | | | | | |
| Innovative/Ref/ | I | I | C | R | R |
| Comp | | | | | |
| Dye intensity | 4 | 5 | 3 | 4 | 2 |
| Dye levelness | 3 | 4 | 3 | 5 | 2 |
| Dye | 2 | 5 | 3 | 1 | 2 |
| penetration | | | | | |
| ISO 105-B06 | 3 | 2¾ | 2 | 2¾ | 2¾ |
| ISO 105-B02 | 3½ | 2½ | 3 | 2½ | 2½ |
| 8 h/100° C. | 4½ | 4¾ | 4½ | 4¾ | 4¾ |
| 48 h/100° C. | 4½ | 4¾ | 4 | 4¾ | 4¾ |
| 168 h/100° C. | 4½ | 4 | 4 | 4¾ | 4 |
| Sum of scores | 29 | 32¾ | 26½ | 32½ | 24¾ |
| COD | 309870 | 472840 | 426571 | 1182000 | 295122 |
| BOD | 61400 | 101900 | 19546 | 0 | 1536 |
| ratio BOD/COD | 19.8% | 21.6% | 4.6% | 0.0% | 0.5% |

‘Itaconic/Maleic’ denotes whether the polymer in the composition in the Example was made from either itaconic acid (I) or maleic acid (M).
‘Starch/CarboxyMethylStarch/Whey/Glycerol/HydroxyethylCellulose/SAccharose’ denotes which naturally occurring material was present while preparing the composition of the Example.
‘Innovative/Ref/Comp’ denotes which example is considered as innovative (I) (i.e. according to the invention), reference (R) (current industry standard) or comparative (C) (not according to the invention).

The innovative Examples 1, 2 and 3, using starch, have a higher sum of scores than the comparative Example 5, and a similar sum of scores compared to comparative Example 6, but comparative Example 6 has a poor score for the important property of Dye levelness.

The innovative Examples 7 and 8, using whey powder, have a higher sum of scores than the comparative Example 9, and a similar sum of scores compared to comparative Example 10, but comparative Example 10 has a poor score for the important property of Dye levelness.

The innovative Example 11, using glycerol, has a higher sum of scores than the comparative Example 12. The innovative Examples 13, 14 and 15 also have a high sum of scores.

These high scores for the innovative Examples are about similar to the sum of scores for the leather treated with industry reference dyeing auxiliary Tanicor M or Tergotan PR.

The BOD₅/COD ratio was much higher for the compositions from Examples 1 to 3 and 5 to 15 than for industry references dyeing auxiliaries Tanicor M and Tergotan PR, as well as compared to comparative Examples 16 and 4.

The overall results indicate that the leathers treated with dyeing auxiliaries from innovative Examples have a high Sum of Scores and those innovative Example compositions have an advantageous BOD₅/COD ratio compared to industry references dyeing auxiliaries Tanicor M and Tergotan PR, whereas the leathers treated with dyeing auxiliaries from comparative Examples either had a low Sum of Scores or had a dye levelness that was not good.

### EXAMPLE 20: RE-TANNING LEATHER IN DRUM PROCESS

The compositions obtained from various Examples were used, as well as Tergotan PR (obtainable from Stahl Europe BV), which is a current industry re-tanning product. The amount of each Re-tanning Agent was selected such that 8% of the non-volatile content of the Re-tanning Agent was added referred to shaved leather weight. This means that for reference Tergotan PR (obtainable from Stahl Europe BV), with a non-volatile content of 30, that 8% addition of non-volatile content means an addition of 26.7% of Tergotan PR.

A full drum process was done starting from Wet-Blue leather tanned with chrome, following below described process.

The percentages are the weight percentages referred to the weight of the shaved leather. The shave thickness was 1.5 mm.

At first the leathers were wetted back. An amount of 300% water of 30° C., 2% of a formic acid solution prepared with 10 parts of formic acid 85% and 100 parts of water and 0.5% of Prosoak (soaking agent, obtainable from Stahl Europe BV) was added into the drum containing the tanned leathers, and the drum was run for 30 minutes, followed by draining the bath. Next, 150% of water of 30° C., 3% of Coralon NL liq (neutralizing agent with buffering properties, obtainable from Stahl Europe BV) and 2% of sodium bicarbonate were added and the drum was run for 90 minutes at a pH in the range 5.0-5.2, followed by draining the drum. The leather in the drum was subsequently washed with 200% of water of 30° C. for 10 minutes and the drum was drained.

An amount of 100% water at 30° C. was added and the Re-tanning Agent (8% of the non-volatile content as indicated above) was added and the drum was run for 30 minutes. Next, 3% of Melioderm HF Brown G p (a dye, obtainable from Stahl Europe BV) was added and the drum was run for 60 minutes, followed by the addition of 100% water at 50° C. and 10% of a formic acid solution prepared with 10 parts of formic acid 85% and 100 parts of water, after which the drum was run for 15 minutes and then drained.

An amount of 200% of water at 50° was added and the drum was run for 10 minutes, followed by draining the drum. An amount of 150% of water of 40° C. was added together with 1.5% of Derminol CST liq (fatliquoring agent, obtainable from Stahl Europe BV) and 5% of Derminol ASN liq (fatliquoring agent, obtainable from Stahl Europe BV) and the drum was run for 40 minutes. Next, an amount of 5% of a formic acid solution prepared with 10 parts of formic acid 85% and 100 parts of water was added and the drum was run for 20 minutes. The drum was drained and the leather in the drum was subsequently washed with 300% of water of 20° C. for 10 minutes and the drum was drained.

### EXAMPLE 21: TESTING OF OBTAINED LEATHER

Specimens from the obtained leather from Example 20 were evaluated on light fastness according to ISO 105-B02 and ISO 105-B06, on heat resistance, dye intensity, dye levelness, dye penetration, superficial touch, fullness and tightness. The test descriptions were already given in previous Example 19.

Dye intensity, dye levelness, dye penetration, tightness, superficial touch and fullness of the leather were evaluated by visual or haptic assessment, rated with standard Grey scale, with a scale ranging from 5 (best) to 1 (worst).

The results are collected in Table 2.

TABLE 2
Properties of leather after re-tanning, and BOD₅/COD results of the various compositions.

| | 1 | 2 | 3 | 4 | 5 | 6 | 7 |
|---|---|---|---|---|---|---|---|
| Itaconic/ | I | I | M | I | I | | I |
| Maleic | | | | | | | |
| Starch/Carboxy | S | S | S | | S | S | W |
| MethylStarch/ | | | | | | | |
| Whey/Glycerol/ | | | | | | | |
| Hydroxyethyl | | | | | | | |
| Cellulose/ | | | | | | | |
| SAccharose | | | | | | | |
| Innovative/Ref/ | I | I | I | C | C | C | I |
| Comp | | | | | | | |
| Dye intensity | 5 | 5 | 5 | 4 | 4 | 5 | 4 |
| Dye levelness | 5 | 3 | 5 | 4 | 4 | 2 | 4 |
| Dye | 3 | 3 | 2 | 4 | 4 | 2 | 4 |
| penetration | | | | | | | |
| Superficial | 3 | 3 | 3 | 3 | 3 | 3 | 4 |
| touch | | | | | | | |
| Tightness | 4 | 5 | 4 | 4 | 4 | 5 | 4 |
| Fullness | 4 | 4 | 2 | 2 | 2 | 2 | 4 |
| ISO 105-B06 | 2½ | 3½ | 2 | 1½ | 1½ | 3 | 1½ |
| ISO 105-B02 | 4 | 4½ | 4 | 3 | 3 | 4½ | 3½ |
| 8 h/100° C. | 4 | 3½ | 3½ | 3½ | 3½ | 4 | 4 |
| 48 h/100° C. | 4 | 3 | 3½ | 3½ | 3½ | 4 | 4 |
| 168 h/100° C. | 4 | 3 | 3½ | 3 | 3 | 3½ | 4 |
| Sum of scores | 42½ | 40½ | 37½ | 35.5 | 35.5 | 38 | 41 |
| COD | 422311 | 365892 | 371658 | 344852 | 344852 | 349696 | 461880 |
| BOD | 27750 | 155838 | 147216 | 31759 | 31759 | 166530 | 44500 |
| ratio BOD/COD | 6.6% | 42.6% | 39.6% | 4 | 9.2% | 47.6% | 9.6% |

| | 8 | 9 | 10 | 11 | 12 | 13 |
|---|---|---|---|---|---|---|
| Itaconic/ | M | I | | I | I | I |
| Maleic | | | | | | |
| Starch/Carboxy | W | W | W | G | G | HC |
| MethylStarch/ | | | | | | |
| Whey/Glycerol/ | | | | | | |
| Hydroxyethyl | | | | | | |
| Cellulose/ | | | | | | |
| SAccharose | | | | | | |
| Innovative/Ref/ | I | C | C | I | C | I |
| Comp | | | | | | |
| Dye intensity | 5 | 4 | 5 | 4 | 31/2 | 5 |
| Dye levelness | 5 | 3 | 2 | 3 | 21/2 | 2 |
| Dye | 2 | 4 | 2 | 3 | 3 | 4 |
| penetration | | | | | | |
| Superficial | 3 | 4 | 3 | 3 | 3 | 2 |
| touch | | | | | | |
| Tightness | 4 | 3½ | 5 | 4½ | 4½ | 4 |
| Fullness | 2 | 3½ | 2 | 2 | 2 | 2 |
| ISO 105-B06 | 2½ | 1½ | 4 | 4 | 3½ | 2½ |
| ISO 105-B02 | 4 | 2½ | 4 | 4 | 3 | 3 |
| 8 h/100° C. | 3 | 3½ | 4 | 4 | 4½ | 5 |
| 48 h/100° C. | 3 | 3½ | 3 | 4 | 3 | 5 |
| 168 h/100° C. | 3 | 3½ | 3 | 3½ | 3½ | 4½ |
| Sum of scores | 36½ | 36½ | 38 | 39 | 36 | 39 |
| COD | 347421 | 470758 | 334850 | 466790 | 473860 | 297462 |
| BOD | 41524 | 66100 | 33200 | 57600 | 166100 | 41614 |
| ratio BOD/COD | 12.0% | 14.0% | 9.9% | 12.3% | 35.1% | 14.0% |

| | | | | Tergotan |
|---|---|---|---|---|
| | 14 | 15 | 16 | PR |
| Itaconic/ | I | I | I | |
| Maleic | | | | |
| Starch/Carboxy | CMS | SA | | |
| MethylStarch/ | | | | |
| Whey/Glycerol/ | | | | |
| Hydroxyethyl | | | | |
| Cellulose/ | | | | |
| SAccharose | | | | |
| Innovative/Ref/ | I | I | C | R |
| Comp | | | | |
| Dye intensity | 5 | 5 | 3 | 3 |
| Dye levelness | 4 | 4 | 3 | 3 |
| Dye | 3 | 5 | 3 | 3 |
| penetration | | | | |
| Superficial | 3½ | 3 | 3 | 3 |
| touch | | | | |
| Tightness | 4 | 5 | 2½ | 3 |
| Fullness | 2 | 2 | 1½ | 3 |
| ISO 105-B06 | 3 | 2 | 2½ | 2½ |
| ISO 105-B02 | 3½ | 3 | 3½ | 3½ |
| 8 h/100° C. | 4½ | 4½ | 4 | 4 |
| 48 h/100° C. | 4½ | 4½ | 4 | 4 |
| 168 h/100° C. | 4½ | 4 | 4 | 3½ |
| Sum of scores | 41½ | 42 | 34 | 35½ |
| COD | 309870 | 472840 | 426571 | 295122 |
| BOD | 61400 | 101900 | 19546 | 1536 |
| ratio BOD/COD | 19.8% | 21.6% | 4.6% | 0.5% |

‘Itaconic/Maleic’ denotes whether the polymer in the composition in the Example was made from either itaconic acid (I) or maleic acid (M).
‘Starch/CarboxyMethylStarch/Whey/Glycerol/HydroxyethylCellulose/SAccharose’ denotes which naturally occurring material was present while preparing the composition of the Example.
‘Innovative/Ref/Comp’ denotes which example is considered as innovative (I) (i.e. according to the invention), reference (R) (current industry standard) or comparative (C) (not according to the invention).

The innovative Examples 1, 2 and 3, using starch, have a higher sum of scores than the comparative Example 5, and a similar or modestly higher sum of scores compared to comparative Example 6, but comparative Example 6 has a poor score for the important property of Dye levelness.

The innovative Example 7, using whey powder, has a higher sum of scores than the comparative Examples 9 and 10. The innovative Example 8, using whey powder, has a similar sum of scores as the comparative Examples 9 and 10.

The innovative Example 11, using glycerol, has a higher sum of scores than the comparative Examples 12 and 4. The innovative Examples 13, 14 and 15 also have a high sum of scores.

These high scores for the innovative Examples are generally higher than the sum of scores for the leather treated with industry reference re-tanning agent Tergotan PR.

The BOD₅/COD ratio was much higher for the compositions from Examples 1 to 3 and from 5 to 15 than for industry reference re-tanning agent Tergotan PR, as well as compared to Comparative Examples 16 and 4.

The overall results indicate that the leathers retanned with compositions from innovative Examples have a high Sum of Scores and those innovative Example compositions have an advantageous BOD₅/COD ratio compared to industry references re-tanning agent Tergotan PR.

1. A process of treating pre-tanned leather, tanned leather, pelts, skins, hides, leather intermediate products, or non-finished leather products, the process comprising:
providing a graft polymer obtainable by polymerizing one or more mono-unsaturated polycarboxylic acids in the presence of naturally occurring polyols and/or naturally occurring polymers; and
dyeing and/or re-tanning said pre-tanned leather,
tanned leather, pelts, skins, hides, leather intermediate products or non-finished leather products using said graft polymer.

2. The process according to claim 1, wherein beside the mono-unsaturated polycarboxylic acids also mono-unsaturated mono-carboxylic acids are used to polymerize the graft polymer and the weight ratio of the mono-unsaturated mono-carboxylic acids to mono-unsaturated polycarboxylic acids used to polymerize the graft polymer is between 10:90 to 0:100.

3. The process according to claim 1, wherein the one or more mono-unsaturated polycarboxylic acids is selected from the group consisting of bio-based mono-unsaturated dicarboxylic acids comprising glutaconic acid, itaconic acid, citraconic acid and mesaconic acid.

4. The process according to claim 1, wherein the one or more naturally occurring polyols or naturally occurring polymers are biobased molecules with multiple hydroxyl groups or are biobased polymers with hydroxyl functionalities.

5. The process according to claim 1, wherein the one or more naturally occurring polyols or naturally occurring polymers are selected from the group consisting of monosaccharides, disaccharides, sugar alcohols, polynucleotides, polypeptides, polysaccharides, lignin, cutin, cutan, melanin, oligosaccharides or mixtures thereof.

6. The process according to claim 1, wherein the one or more naturally occurring polyols are selected from the group consisting of erythrose, threose, ribose, arabinoase, xylose, lyxose, allose, altrose, glucose, mannose, gulose, idose, galactose, talose, erythrulose, ribulose, xylulose, psicose, fructose, sorbose, tagatose, pyrosides, sucrose, lactose, maltose, trehalose, cellobiose, chitobiose, kojibiose, nigerose, isomaltose, sophorose, laminasribiose, gentiobiose, trehalulose, turanose, maltulose, leucrose, isomaltose, gentiobiulose, mannobiose, melibiose, melibiulose, rutinose, rutinulose, xylobiose, glycerol, eythritol, threitol, arabitol, xylitol, ribitol, mannitol, sorbitol, galactitol, fucitol, iditol, inositol, volemitol, isomalt, maltitol, lactitol, and the naturally occurring polymers are selected from the group consisting of casein protein, whey protein, amylose, starch, functionalized starch, glycogen, galactogen, inulin, pectin, cellulose, functionalized cellulose, alginate, lignin, cutin, cutan, melanin, maltodextrins, raffinose, stachyose and fructosaccharide and mixtures thereof.

7. The process according to claim 1, wherein the weight ratios between the one or more mono-unsaturated polycarboxylic acids and the one or more naturally occurring polyols and/or naturally occurring polymers are between 10 and 500 parts of the one or more mono-unsaturated polycarboxylic acids to 100 parts one or more naturally occurring polyols and/or polymers, wherein the parts are referring to the mass of the non-volatile components therein.

8. The process according to claim 1, where said graft polymer is used in a composition further comprising additives and optionally naturally occurring polyol or naturally occurring polymer.

9. The process according to claim 8, wherein the amount of the one or more mono-unsaturated polycarboxylic acids employed to prepare the graft polymer contributes between 5 and 80 weight %, preferably between 8 and 70 weight %, on the total composition considering only the non-volatile components therein.

10. The process according to claim 8, wherein the amount of the one or more naturally occurring polyols and/or naturally occurring polymers employed to prepare the graft polymer contributes between 5 and 90 weight %, preferably between 10 and 85 weight %, on the total composition considering only the non-volatile components therein.

11. The process according to claim 8, wherein the composition is liquid at ambient conditions.

12. The process according to claim 8, wherein the composition is a solution in water or a dispersion in water.

13. The process according to claim 8, wherein the composition comprises one or more water-miscible organic solvents of up to 30% by weight of the overall weight of the composition.

14. The process according to any claim 8, wherein the composition has a BOD5/COD ratio of higher than 5%.

15. (canceled)

16. A leather, obtained by the process of claim 1.

17. The leather according to claim 16 having a good dye intensity, dye levelness, tightness, heat resistance and good lightfastness according to ISO105-B02 and/or to ISO105-B06.

18. A process for preparing a graft polymer as defined in claim 1, comprising the step of free radical polymerization of one or more mono-unsaturated polycarboxylic acids in the presence of naturally occurring polyols and/or naturally occurring polymers.

19. The process according to claim 14, wherein the composition has a BOD5/COD ratio of higher than 10%.
